(19) United States
(12) Patent Application Publication
(10) Pub. No.: US 2020/0060445 A1
(43) Pub. Date: Feb. 27, 2020

(54) PLANT CONTAINER DECORATIVE SLEEVE AND METHOD OF USE

(71) Applicant: Joseph Andolina, San Jose, CA (US)

(72) Inventor: Joseph Andolina, San Jose, CA (US)

(21) Appl. No.: 16/110,786

(22) Filed: Aug. 23, 2018

(51) Int. Cl. A47G 7/08; A01G 9/02

(52) U.S. Cl. CPC A47G 7/08; A01G 9/02

(57) ABSTRACT

A plant container decoration system includes a plant container having a base and a top opening into the plant container, the plant container to hold a plant; a sleeve to removably engage with the plant container, the sleeve having a top opening to receive the plant container and secure around the top of the container via a securement device; and a bottom to secure at the base of the plant container; the sleeve provides a decorative cover around the plant container.

### BACKGROUND

### 1. Field of the Invention

The present invention relates generally to potted plant systems, and more specifically, to a plant container decorative sleeve and method of use, that provides for a quick and convenient means to decorate a potted plant without replanting.

### 2. Description of Related Art

Potted plant systems are well known in the art and are effective means to purchase and transport plants. For example, FIG. 1 depicts a conventional potted plant system 101 having a plant 103 planted within a container 105 having a top 107 and a base 109. Conventionally, the container 105 is black or undecorated, therefore, it is desirable for the user to replant in order to place the plant in an aesthetically pleasing container.

One of the problems commonly associated with system 101 is inconvenience. For example, plants can be difficult to replant, and further such re-planting can cause damage to the plant.

Accordingly, although great strides have been made in the area of potted plant systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a common potted plant system;

FIGS. 2A and 2B are front views of a plant container decoration system with a decorative sleeve in accordance with a preferred embodiment of the present application;

FIG. 3 is a front view of the system of FIGS. 2A and 2B with a cross sectional view of the sleeve;

FIG. 4 is a top view of the system of FIGS. 2A and 2B with the plant removed for clarity; and

FIG. 5 is a flowchart of the method of use of the system of FIGS. 2A and 2B.

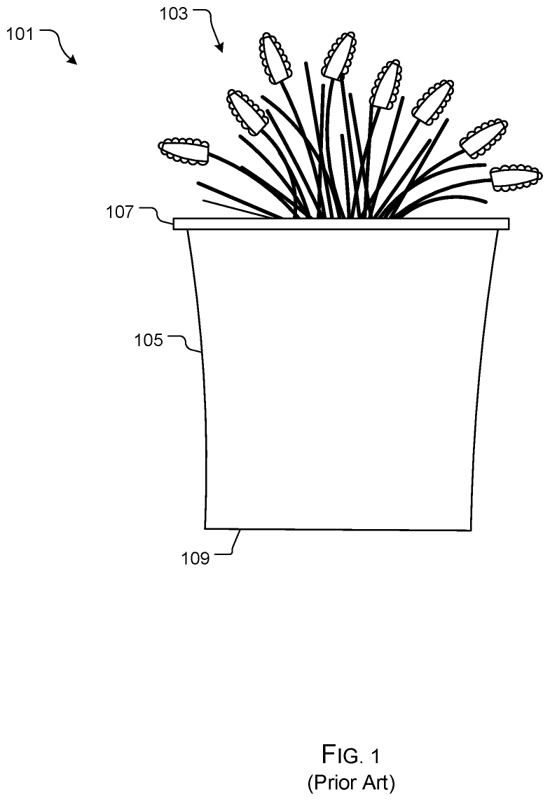

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional potted plant systems. Specifically, the present invention provides for a decorative sleeve to cover an aesthetically unappealing container in a quick and efficient manner. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

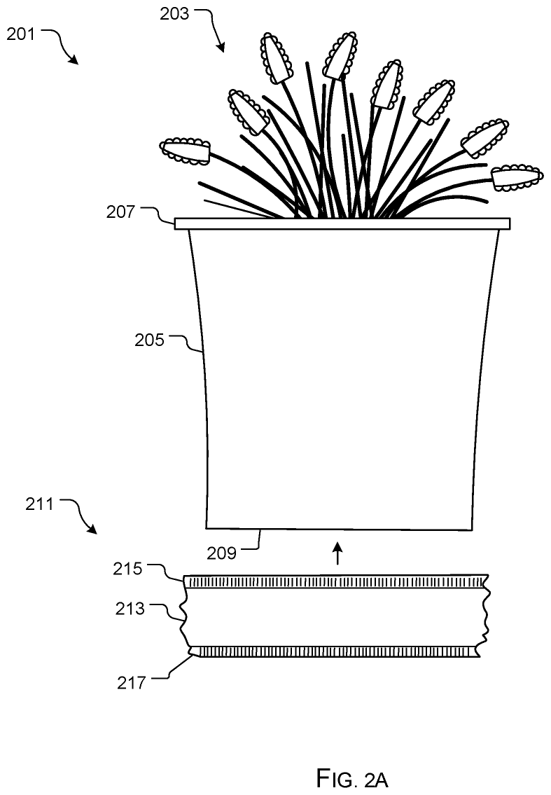

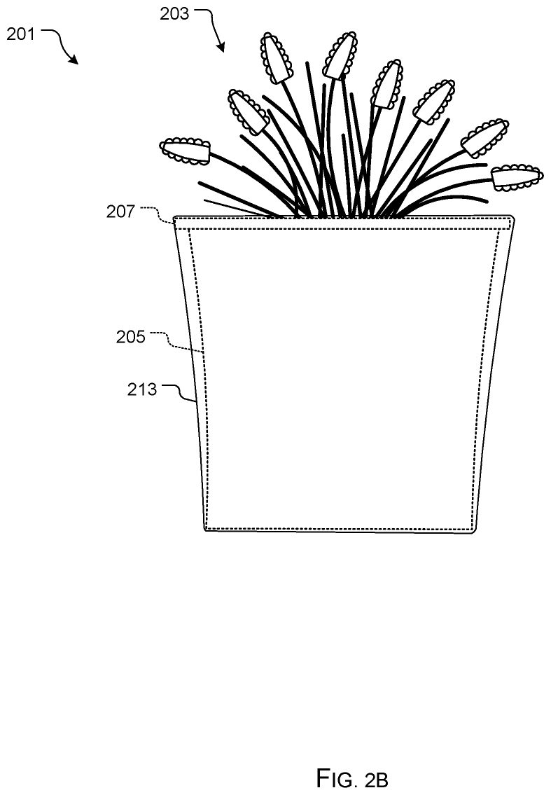

Referring now to the drawings wherein like reference characters identify corresponding or similar elements throughout the several views, FIGS. 2A and 2B depict front views of a plant container decoration system 101 in accordance with a preferred embodiment of the present application. It will be appreciated that system 201 overcomes one or more of the above-listed problems commonly associated with conventional potted plant systems.

In the contemplated embodiment, system 201 includes a plant 203 potted within a plant container 205, the plant container 205 having a top 207 and a base 209. It should be appreciated that the container is not limited to size or style, and can be rectangular, round, or any other shape. System 201 further includes a sleeve 211 configured to engage with container 205 via a top opening 401. Sleeve 211 includes a body 213 and at least one securement device 215, such as an elastic band, integral with a top of the sleeve and thereby being configured to secure the sleeve about the top 207 of container 205. The sleeve 211 can include a second securement device 217 positioned at the bottom and therefore configured to retain the bottom of the sleeve about the base 209 of the container 205.

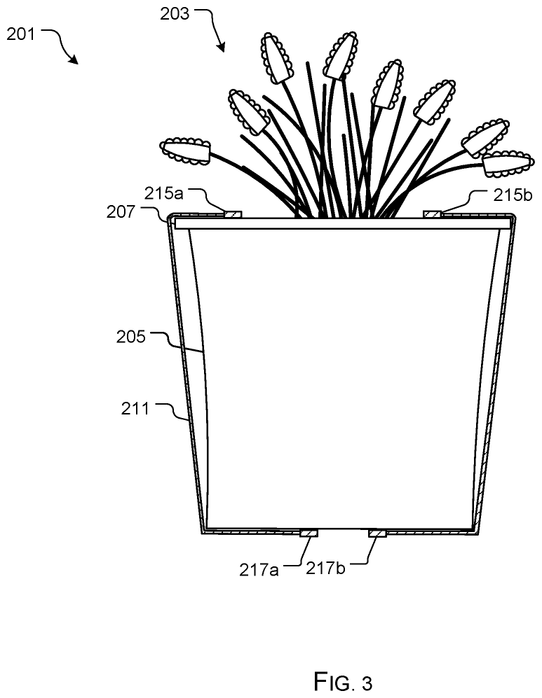

As better shown in FIG. 3, the securement devices 215, 217 (which in the preferred embodiment are elastic bands being sewn, or otherwise integrated into the body) provide for a means to retain the sleeve in place about container 205. It should be appreciated that body 213 of sleeve 211 can be composed of a variety of materials, however, in a preferred embodiment, the sleeve is flexible and stretchy, thereby providing a means for the sleeve to fit about variously sized container.

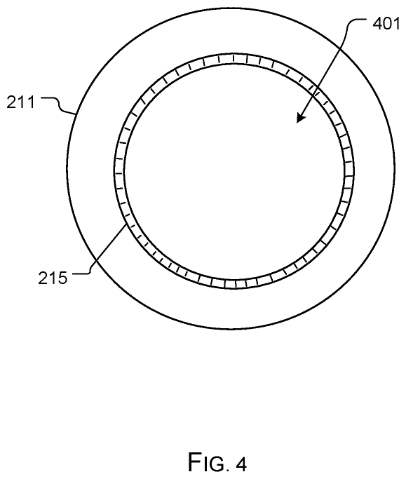

As further shown in FIG. 4, top securement device 215 is positioned about opening 401 which provides access into the plant container, and space for the plant 203.

It should be appreciated that one of the unique features believed characteristic of the present application is the use of a sleeve to provide aesthetical appeal to a plant container. The sleeve provides a means to allow a user to quickly decorate a container, without the need to repot the plant, thereby saving time and money. The sleeve can include prints, embellishments, or the like for further customization. It should be appreciated that the primary purpose of the sleeve is for use with stock garden containers, such as are purchased from nurseries. However, it should be appreciated that the sleeve could alternatively be used with other plant containers as well.

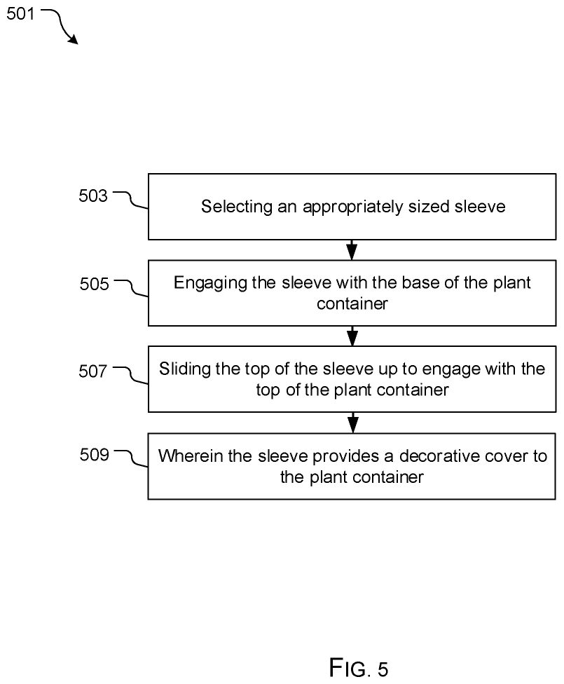

In FIG. 5, a flowchart 501 depicts a method of use of system 201. During use, after the user purchases a plant in a container, the user selects an appropriately sized sleeve and engages the sleeve around the container, as shown with boxes 503, 505. The user slides the sleeve up, wherein the securement device retains the top of the sleeve about a top of the container, as shown with box 507. The sleeve thereby provides for an improved aesthetical appearance, as shown with box 509.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A plant container decoration system, comprising:
a plant container having a base and a top opening into the plant container, the plant container configured to hold a plant;
a sleeve configured to removably engage with the plant container, the sleeve having:
a top opening configured to receive the plant container and secure around the top of the container via a securement device; and
a bottom configured to secure at the base of the plant container;
wherein the sleeve provides a decorative cover around the plant container.

2. The system of claim 1, wherein the securement device is elastic.

3. The system of claim 1, further comprising:
a second elastic securement device incorporated into the bottom of the sleeve and configured to secure the bottom of the sleeve to the base of the plant container.

4. A method of decorating a plant container, the method comprising:
providing the system of claim 1;
engaging the sleeve with the plant container wherein the sleeve extends from the base to the top of the plant container; and
securing the sleeve to the plant container via the securement device.
